(19) United States
(12) Patent Application Publication
(10) Pub. No.: US 2020/0136142 A1
(43) Pub. Date: Apr. 30, 2020

(54) ACTIVE MATERIAL FOR ELECTRODE AND METHOD OF MANUFACTURING THEREOF

(71) Applicant: Tesla, Inc., Palo Alto, CA (US)

(72) Inventors: Sanketh R. Gowda, Redwood City, CA (US); Vineet Haresh Mehta, Mountain View, CA (US)

(21) Appl. No.: 16/662,702

(22) Filed: Oct. 24, 2019

Related U.S. Application Data
(60) Provisional application No. 62/750,528, filed on Oct. 25, 2018.

(51) Int. Cl. H01M 4/525; H01M 4/62; C01G 53/00

(52) U.S. Cl. CPC H01M 4/525; H01M 4/625; H01M 2004/028; C01G 53/42; H01M 4/623

(57) ABSTRACT

An active material for an electrode and its methods of manufacture are provided. The active material includes a lithium-nickel-copper complex oxide (LNCO) represented by the formula Li₂NiₓCu₁₋ₓO₂, wherein x is greater than 0 and less than 1.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims priority to U.S. Provisional App. No. 62/750,528 filed on Oct. 25, 2018, which is hereby incorporated by reference in its entirety.

### BACKGROUND

### Field

The present disclosure relates to electrodes for use in batteries, an active material for producing the electrodes, and the manufacture of the active material.

### Description of the Related Art

Batteries with lithium-based chemistries are used in various applications. Such batteries often include a lithium-based cathode. Batteries with conventional lithium-based cathodes may have low capacity and low efficiency.

### SUMMARY

The present disclosure describes an active material for an electrode, in particular one that may be used as a prelithiation source. The active material includes a lithium-nickel-copper complex oxide represented by the formula Li₂NiₓCu₁₋ₓO₂, wherein x is greater than 0 and less than 1.

In another embodiment, an electrode for a battery is provided. The electrode includes an active material, a binder and carbon. The active material includes a lithium-nickel-copper complex oxide represented by the formula Li₂NiₓCu₁₋ₓO₂, wherein x is greater than 0 and less than 1.

In another embodiment, a battery is provided. The battery includes a cathode and an anode. The cathode includes an active material. The active material includes a lithium-nickel-copper complex oxide represented by the formula Li₂NiₓCu₁₋ₓO₂, wherein x is greater than 0 and less than 1.

In yet another embodiment, a method of manufacturing an active material for an electrode is provided. The method includes using precursors including lithium hydroxide (LiOH), copper(II) oxide (CuO) and nickel(II) oxide (NiO). The method further includes heating the precursors to generate a lithium-nickel-copper complex oxide represented by the formula Li₂NiₓCu₁₋ₓO₂, wherein x is greater than 0 and less than 1.

In another embodiment, a method of manufacturing an active material for an electrode is provided. The method includes using precursors including a metal oxalate hydrate represented by the formula MC₂O₄.2H₂O, wherein M is nickel and copper. The method further includes heating the precursors to generate a lithium-nickel-copper complex oxide represented by the formula Li₂NiₓCu₁₋ₓO₂, wherein x is greater than 0 and less than 1.

In one aspect, an active material for an electrode is described. The active material includes a lithium-nickel-copper complex oxide (LNCO) represented by the formula Li₂NiₓCu₁₋ₓO₂, wherein x is greater than 0 and less than 1.

In some embodiments of the active material, x is about 0.2 to about 0.8. In some embodiments, x is 0.3, 0.5 or 0.7. In some embodiments, the active material further comprises a lithium-nickel-cobalt-aluminum complex oxide (NCA).

In another aspect, an electrode film for a battery is described. The electrode film comprises the active material, a binder, and a carbon material.

In some embodiments of the electrode film, the active material comprises about 98% by weight of the electrode film. In some embodiments, the binder comprises about 1% by weight of the electrode film. In some embodiments, the binder comprises polyvinlylidene fluoride (PVDF). In some embodiments, the carbon material comprises about 1% by weight of the electrode film. In some embodiments, the carbon material is selected from the group consisting of carbon black, acetylene black, and a conductive additive, or combinations thereof. In some embodiments, the LNCO comprises at least about 0.5% by weight of the electrode film. In some embodiments, the active material further comprises a lithium-nickel-cobalt-aluminum complex oxide (NCA). In some embodiments, the NCA comprises at least about 96% by weight of the electrode film. In some embodiments, the ratio of NCA:LNCO by weight of the electrode film is about 48:1-9:1.

In another aspect an electrode for a battery is described. The electrode includes the electrode film, and a current collector.

In another aspect a battery is described. The battery includes the electrode. In some embodiments, the electrode is a cathode electrode.

In another aspect a method of manufacturing an active material for an electrode is described. The method includes forming a precursor comprising lithium hydroxide (LiOH), copper(II) oxide (CuO) and nickel(II) oxide (NiO), heating the precursor to generate a lithium-nickel-copper complex oxide (LNCO) represented by the formula Li₂NiₓCu₁₋ₓO₂, wherein x is greater than 0 and less than 1, and forming an active material comprising the LNCO.

In some embodiments of the method, the method further comprises grinding the precursor after the precursor is formed. In some embodiments, the method further comprises milling the lithium-nickel-copper complex oxide. In some embodiments, the method further comprises mixing the lithium-nickel-copper complex oxide with a lithium-nickel-cobalt-aluminum complex oxide (NCA). In some embodiments, the precursor is heated in an inert atmosphere. In some embodiments, the precursor is heated at a temperature of about 650° C. to about 750° C. In some embodiments, the precursor is heated at a temperature of about 700° C. In some embodiments, the method further comprises surface coating the active material with alumina (Al₂O₃).

In another aspect a method of manufacturing an active material for an electrode is described. The method includes forming a first precursor comprising a metal oxalate hydrate represented by the formula MC₂O₄.2H₂O, wherein M is nickel and copper, heating the first precursor to form a metal oxide, heating the metal oxide with a lithium precursor to generate a lithium-nickel-copper complex oxide (LNCO) represented by the formula Li₂NiₓCu₁₋ₓO₂, wherein x is greater than 0 and less than 1, and forming an active material comprising the LNCO.

In some embodiments of the method, the first precursor is formed by reacting Na₂C₂O₄ with MSO₄. In some embodiments, the lithium precursor is lithium hydroxide (LiOH). In some embodiments, heating the first precursor is performed at about 400° C. to about 500° C. In some embodiments, heating the first precursor is performed in an atmosphere comprising oxygen. In some embodiments, heating the metal oxide with the lithium precursor is performed at about 650° C. to about 750° C. In some embodiments, heating the metal oxide with the lithium precursor is performed in an inert atmosphere.

### BRIEF DESCRIPTION OF THE DRAWINGS

FIG. 1 is a schematic diagram illustrating a battery constructed according to the present disclosure.

FIG. 2 is a flowchart illustrating a method of manufacturing an active material for an electrode according to the present disclosure.

FIG. 3 is a plot illustrating an expected X-ray powder diffraction of a complex oxide according to the present disclosure.

FIG. 4 is a plot illustrating measured X-ray powder diffraction of different complex oxide samples according to the present disclosure.

FIG. 5 is a plot illustrating voltage versus charge capacity for a Li₂Ni_{0.3}Cu_{0.7}O₂ complex oxide sample according to the present disclosure.

FIG. 6 is a plot illustrating voltage versus charge capacity for a Li₂Ni_{0.5}Cu_{0.5}O₂ complex oxide sample according to the present disclosure.

FIG. 7 is a plot illustrating voltage versus charge capacity for a Li₂Ni_{0.5}Cu_{0.3}O₂ complex oxide sample according to the present disclosure.

FIG. 8 is a plot illustrating voltage versus charge capacity for different half cells having 0% Lithium-Nickel-Copper Complex Oxide (LNCO) or 2% LNCO according to the present disclosure.

FIG. 9 is a plot illustrating voltage versus charge capacity for different full cells having 0% LNCO or 2% LNCO according to the present disclosure.

### DETAILED DESCRIPTION

Embodiments relate to active materials used in battery electrodes to improve charge capacity of the battery. For example, the active material in the electrode may contain a lithium-nickel-copper complex oxide (LNCO) represented by the formula Li₂NiₓCu₁₋ₓO₂, wherein x is greater than 0 and less than 1. The presence of the LNCO, as described below, may result in the battery electrode having a higher first charge capacity in comparison to electrodes that do not contain the LNCO.

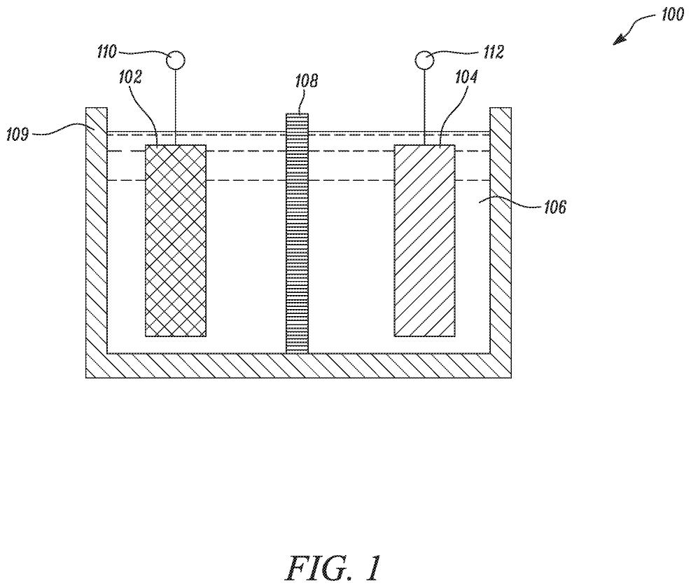

FIG. 1 is a schematic diagram illustrating a battery 100 constructed according to the present disclosure. In some embodiments, battery 100 is a rechargeable or secondary battery. Alternatively, battery 100 may be a non-rechargeable or primary battery. Battery 100 includes a cathode 102, an anode 104, an electrolyte 106, a separator 108 and a housing 109. Both cathode 102 and anode 104 contact electrolyte 106. Electrolyte 106 may be a liquid electrolyte or a solid electrolyte. Separator 108 is disposed between cathode 102 and anode 104 to prevent internal short circuit between cathode 102 and anode 104. A cathode terminal 110 is connected to cathode 102. An anode terminal 112 is connected to anode 104. Cathode terminal 110 and anode terminal 112 may be selectively connected to a load (not shown) or a charger (not shown) during discharge or charging, respectively, of battery 100.

In the illustrated embodiment of FIG. 1, battery 100 includes a single electrochemical cell. However, battery 100 may include any number of electrochemical cells based on application requirements. For example, battery 100 may be a battery pack including multiple electrochemical cells arranged in series, parallel or a combination thereof to deliver a desired voltage, capacity, and/or power density.

In some embodiments, battery 100 is a lithium-ion (Li-ion) battery in which lithium ions move from cathode 102 to anode 104 during discharge and move from anode 104 to cathode 102 during charging. The present disclosure is further related to an active material for an electrode. The electrode may be a cathode or an anode. In an embodiment, the electrode is cathode 102 of battery 100. In some embodiments, an electrode, such as cathode 102 and/or anode 104, may have a lithium-based chemistry. In some embodiments, the electrode includes an electrode film and a current collector. In some embodiments, the electrode film includes an active material.

In one embodiment, the active material in an electrode includes a lithium-nickel-copper complex oxide (LNCO) represented by the formula Li₂NiₓCu₁₋ₓO₂, wherein x is greater than 0 and less than 1. In some embodiments, x is or is about 0.05, 0.1, 0.2, 0.3, 0.4, 0.5, 0.6, 0.7, 0.8, 0.9 or 0.95, or any range of values therebetween. For example, in some embodiments x is a value in the range of about 0.05 to about 0.95, about 0.2 to about 0.8, about 0.1 to about 0.6, or about 0.4 to about 0.9. In some embodiments, x is at least one of 0.3, 0.5 and 0.7.

In some embodiments, the active material includes or incudes about 90%, 91%, 92%, 93%, 94%, 95%, 96%, 97%, 98%, 99% or 99.5% by weight of the electrode film, or any range of values therebetween. For example, in some embodiments the active material incudes about 90%-99.5%, about 95%-99%, or about 96%-99% by weight of the electrode film. In some embodiments, the active material includes about 98% by weight of the electrode film.

In some embodiments, electrode film further includes a binder in addition to the active material. In some embodiments, electrode film further includes a carbon material in addition to the active material. In an embodiment, the binder includes or includes about 0.2%, 0.4%, 0.6%, 0.8%, 1%, 1.2%, 1.4%, 1.5%, 1.8% or 2% by weight of the electrode film, or any range of values therebetween. For example, in some embodiments the binder includes about 0.2%-2%, about 0.5%-1.5%, about 0.4%-1.2% or about 0.8%-1.8% by weight of the electrode film. In an embodiment, the binder includes about 1% by weight of the electrode film. In some embodiments, the binder may be a polymeric binder, such as for example polyvinlylidene fluoride (PVDF). In an embodiment, the carbon material includes or includes about 0.2%, 0.4%, 0.6%, 0.8%, 1%, 1.2%, 1.4%, 1.5%, 1.8% or 2% by weight of the electrode film, or any range of values therebetween. For example, in some embodiments the carbon material includes about 0.2%-2%, about 0.5%-1.5%, about 0.4%-1.2% or about 0.8%-1.8% by weight of the electrode film. In some embodiments, the carbon material includes about 1% by weight of the electrode film. In some embodiments, the carbon material is selected from the group consisting of carbon black acetylene black, and a conductive additive, or combinations thereof.

In some embodiments, the lithium-nickel-copper complex oxide (LNCO) includes at least, includes at least about, includes about, or includes 0.1%, 0.3%, 0.5%, 0.7%, 1%, 1.5%, 2%, 3%, 5%, 7%, 8%, 9%, 10%, 12% or 15% by weight of the electrode film, or any range of values therebetween. For example, in some embodiments the lithium-nickel-copper complex oxide (LNCO) includes about 0.1%-15%, 1%-10%, 0.5%-7%, 2%-12% or 2%-8% by weight of the electrode film. In some embodiments, the lithium-nickel-copper complex oxide (LNCO) includes at least 0.5% by weight of the electrode film. In some other embodiments, the lithium-nickel-copper complex oxide (LNCO) includes at least 1%, 2%, 5%, 8% or 10% by weight of the electrode film.

In a further embodiment, the electrode film further includes a lithium-nickel-cobalt-aluminum complex oxide (NCA). In an embodiment, the NCA includes or incudes about 90%, 91%, 92%, 93%, 94%, 95%, 96%, 97%, 98%, 99% or 99.5% by weight of the electrode film, or any range of values therebetween. For example, in some embodiments the active material incudes about 90%-99.5%, about 94%-98%, or about 93%-99% by weight of the electrode film. In an embodiment, the NCA includes about 96% by weight of the electrode film.

### Method of Preparing Active Material

In some embodiments, the active material is obtained or manufactured by forming a precursor including lithium hydroxide (LiOH), copper(II) oxide (CuO) and nickel(II) oxide (NiO), and heating the precursor to generate the lithium-nickel-copper complex oxide (LNCO). In some embodiments, the precursor is heated by a baking or heating process in inert atmosphere. In some embodiments, the precursor is heated by a baking or heating process in an atmosphere comprising oxygen (e.g. air). In some embodiments, heating of the precursor forms the LNCO.

In an embodiment, hardness of the precursor increases with nickel (Ni) content. Hardness may impact grinding or milling conditions after the baking process. As hardness of the material increases, grinding may become more difficult.

In some other embodiments, the lithium-nickel-copper complex oxide (LNCO) is synthesized by an oxalate method that includes generating a metal oxalate hydrate as a precipitate by reacting sodium oxalate (Na₂C₂O₄) with MSO₄. The metal oxalate hydrate is represented by the formula MC₂O₄.2H₂O, wherein M is nickel and copper. MC₂O₄.2H₂O is then heated to generate a metal oxide. The metal oxide is then heated with a lithium precursor to generate the lithium-nickel-copper complex oxide (LNCO). In an embodiment, the lithium precursor is lithium hydroxide (LiOH). In some embodiments, the lithium-nickel-cobalt-aluminum complex oxide (NCA) is also synthesized using the oxalate method where M is chosen accordingly.

The active material of the present disclosure may be used in a half-cell or a full cell. In some embodiments, the active material is used in at least one of a coin cell and a pouch cell.

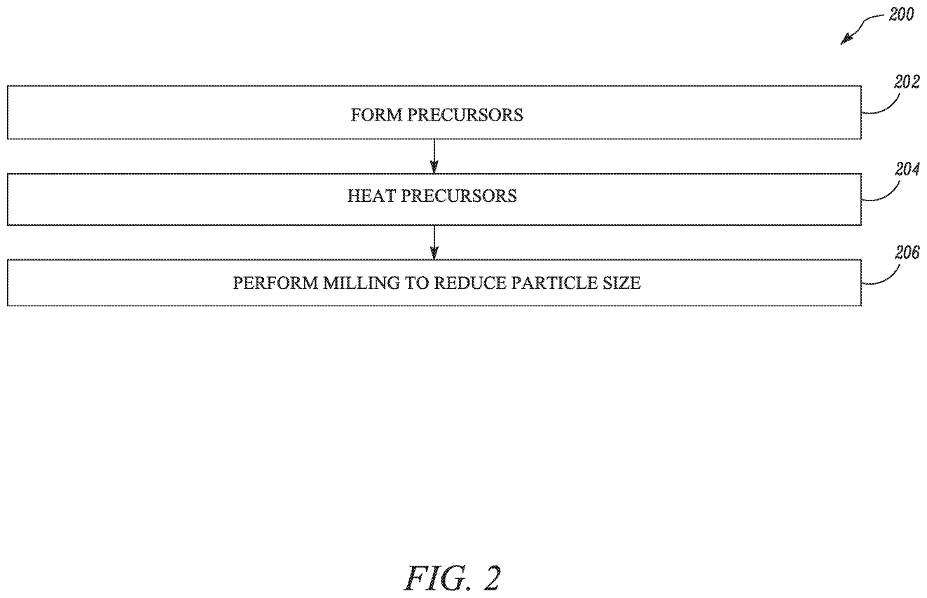

FIG. 2 illustrates a method 200 of manufacturing the active material for the electrode according to the present disclosure. The method 200 may be used for synthesizing the lithium-nickel-copper complex oxide (LNCO). At step 202, the method 200 includes forming precursors. In some embodiments, the precursors include lithium hydroxide (LiOH), copper(II) oxide (CuO) and nickel(II) oxide (NiO). LiOH may be provided in excess in the precursors, for example, about 1%, 2%, 3%, 4%, 5%, 6%, 8% or 10% in excess of a required amount. The different precursor materials, i.e., LiOH, CuO and NiO, may be mixed in a predetermined weight ratio to form the precursors. In some embodiments, the method 200 further includes grinding the precursors including LiOH, CuO and NiO. The precursors may be subjected to grinding using suitable grinding equipment. In other embodiments, the precursor materials LiOH, CuO and NiO are subjected to grinding separately and then mixed together to form the precursors.

At step 204, the method 200 further includes heating the precursors to generate the lithium-nickel-copper complex oxide (LNCO) represented by the formula Li₂NiₓCu₁₋ₓO₂, wherein x is greater than 0 and less than 1. In some embodiments, the precursors are heated in an inert gas atmosphere. The inert gas atmosphere may be an atmosphere including helium (He), nitrogen (N₂), argon (Ar), and/or other inert gasses. In some embodiments, the precursors are heated at a temperature of or of about 600° C., 625° C., 650° C., 660° C., 670° C., 680° C., 690° C., 700° C., 710° C., 720° C., 730° C., 740° C., 750° C., 775° C. or 800° C., or any range of values therebetween. For example, in some embodiments the precursors are heated at a temperature about 600° C.-800° C., 650° C.-750° C., 625° C.-730° C. or 670° C.-775° C. In some embodiments, the precursors are heated at a temperature of about 700° C. In some embodiments, the precursors are heated for a time period of or of about 4, 5, 6, 7, 8, 9, 10, 11 or 12 hours, or any range of values therebetween. For example, in some embodiments the precursors are heated for a time period of about 4-12, about 6-10, about 5-9 or about 7-11 hours. In some embodiments, the precursors are heated for a time period of about 8 hours. Heating of the precursors may be performed in a furnace.

In some other embodiments, the method 200 includes forming the precursors by the oxalate method. The precursors include a metal oxalate hydrate represented by the formula MC₂O₄.2H₂O, wherein M is nickel (Ni) and copper (Cu). Precursor synthesis by the oxalate method is provided by Equation 1 provided below:

Na₂C₂O₄+MSO₄→MC₂O₄.2H₂O (ppt.)+2Na⁺+SO₄²⁻ Equation 1

M in Equation 1 is Ni/Cu for the synthesis of the lithium-nickel-copper complex oxide (LNCO). However, M can be varied based on the compound being synthesized. For example, M can be nickel or any other combination of metals. Equation 1 may also be used for the synthesis of a precursor using in the formation of the lithium-nickel-cobalt-aluminum complex oxide (NCA).

In some other embodiments, the method 200 includes a modified calcination process to generate the lithium-nickel-copper complex oxide (LNCO) represented by the formula Li₂NiₓCu₁₋ₓO₂, wherein x is greater than 0 and less than 1. The modified calcination process is implemented on MC₂O₄.2H₂O which is generated as a precipitate by the oxalate method as shown in Equation 1. The modified calcination process includes two steps as shown by Equation 2 and Equation 3.

MC₂O₄.2H₂O→Metal oxide+gases Equation 2

Metal oxide+Li precursor→Li precursor→Li₂MO₂+gases Equation 3

The MC₂O₄.2H₂O is first heated to form the metal oxide. In some embodiments, the MC₂O₄.2H₂O is heated in an atmosphere comprising oxygen (e.g. air). In some embodiments, the MC₂O₄.2H₂O is heated at a temperature of or of about 400° C., 410° C., 420° C., 430° C., 440° C., 450° C., 460° C., 470° C., 480° C., 490° C. or 500° C., or any range of values therebetween. For example, in some embodiments the MC₂O₄.2H₂O is heated at a temperature of about 400° C.-500° C. or about 430° C.-470° C. In some embodiments, the MC₂O₄.2H₂O is heated at a temperature of about 450° C. In some embodiments, the MC₂O₄.2H₂O is heated for or for about 2, 3, 4, 5, 6, 7, 8, 9 or 10 hours, or any range of values therebetween. For example, in some embodiments the MC₂O₄.2H₂O is heated for about 2-10 or 4-8 hours. In some embodiments, the MC₂O₄.2H₂O is heated for about 6 hours.

The metal oxide is heated with a lithium precursor to generate Li₂MO₂. In some embodiments, the metal oxide and lithium precursor are heated in an inert atmosphere (e.g. helium, nitrogen, argon, or combinations thereof). In some embodiments, the metal oxide and lithium precursor are heated in an inert atmosphere of argon. In some embodiments, the metal oxide and lithium precursor are heated at a temperature of or of about 600° C., 625° C., 650° C., 660° C., 670° C., 680° C., 690° C., 700° C., 710° C., 720° C., 730° C., 740° C., 750° C., 775° C. or 800° C., or any range of values therebetween. For example, in some embodiments the MC₂O₄.2H₂O is heated at a temperature of about 600° C.-800° C., 650° C.-750° C., 625° C.-730° C. or 670° C.-775° C. In some embodiments, the metal oxide and lithium precursor are heated at a temperature of about 700° C. In some embodiments, the metal oxide and lithium precursor are heated for or for about 2, 3, 4, 5, 6, 7, 8, 9, 10 or 12 hours, or any range of values therebetween. For example, in some embodiments the metal oxide and lithium precursor are heated for about 2-12 or 6-10 hours. In some embodiments, the metal oxide and lithium precursor are heated for about 8 hours. The Li₂MO₂ is the lithium-nickel-copper complex oxide (LNCO) represented by the formula Li₂NiₓCu₁₋ₓO₂, wherein x is greater than 0 and less than 1.

M in Li₂MO₂ is Ni/Cu for the synthesis of the lithium-nickel-copper complex oxide (LNCO). However, M can be varied based on the compound being synthesized. For example, M can be Nickel or any other combination of metals. Equations 2 and 3 may also be used for the synthesis of the lithium-nickel-cobalt-aluminum complex oxide (NCA).

At step 206, the method 200 includes milling to reduce particle size. Specifically, the method 200 may include milling or grinding the lithium-nickel-copper complex oxide (LNCO) generated at step 204. Milling may be performed to obtain a desired particle size distribution (PSD) of the lithium-nickel-copper complex oxide (LNCO). Milling may be performed using suitable milling equipment.

The method 200 may include further steps to improve a bimodal PSD. The method 200 may further include reduction of lithium carbonate (Li₂CO₃) residue and/or lithium hydroxide (LiOH) residue.

In an embodiment, the method 200 produces a mixture or a solid solution of different lithium-nickel-copper complex oxides with different values of x, where x corresponds to the coefficient of nickel (Ni) in the lithium-nickel-copper complex oxide (LNCO). In some embodiments, x is or is about 0.05, 0.1, 0.2, 0.3, 0.4, 0.5, 0.6, 0.7, 0.8, 0.9 or 0.95, or any range of values therebetween. For example, in some embodiments x is a value in the range of about 0.05 to about 0.95, 0.2 to about 0.8, about 0.1 to about 0.6, or about 0.4 to about 0.9. For example, the method 200 may produce a solid solution of Li₂Ni_{0.3}Cu_{0.7}O₂, Li₂Ni_{0.5}Cu_{0.5}O₂ and/or Li₂Ni_{0.7}Cu_{0.3}O₂.

The method 200 further includes mixing the lithium-nickel-copper complex oxide (LNCO) with the lithium-nickel-cobalt-aluminum complex oxide (NCA) to obtain the active material for the electrode. LNCO and NCA may be mixed in a predetermined weight ratio. In an embodiment, the weight ratio of NCA to LNCO in the active material is or is about 60:1, 55:1, 50:1, 48:1, 45:1, 40:1, 35:1, 30:1, 25:1, 20:1, 15:1, 12:1, 11.5:1, 10:1, 9:1, 8:1 or 5:1, or any range of values therebetween. For example, in some embodiments, the weight ratio of NCA to LNCO in the active material is about 60:1-5:1, about 48:1-9:1, about 19:1-5:1, or about 50:1-8:1. In an embodiment, the weight ratio of NCA to LNCO in the active material is about 48:1. In some other embodiments, the weight ratio of NCA to LNCO in the active material is about 19:1, 23:2, or 9:1.

In some embodiments, the method 200 further includes surface coating an electrode film or the active material with alumina (Al₂O₃). An exemplary process of synthesizing Al₂O₃ coated Li₂Ni_{0.5}Cu_{0.5}O₂ (i.e., x=0.5) is described hereinafter. In an embodiment, an objective of the synthesis is to obtain a 1% by weight Al₂O₃ coating on Li₂Ni_{0.5}Cu_{0.5}O₂. The process may be conducted inside a sealed container, such as a glovebox. The process may include dissolving about 30 milligrams (mg) aluminum isopropoxide into about 50 grams (g) anhydrous ethanol. About 1.5 g of Li₂Ni_{0.5}Cu_{0.5}O₂ may be then added into the solution. The solution may be stirred for a predetermined amount of time (e.g., about 48 hours) to cause precipitation. The precipitate may be heated at a predetermined temperature for a predetermined amount of time (e.g., about 4 hours). The predetermined temperature may be about 120° C., 300° C. or 500° C.

In an embodiment, the method further includes surface coating Al₂O₃ on the electrode film or active material including lithium-nickel-copper complex oxide (LNCO) and lithium-nickel-cobalt-aluminum complex oxide (NCA).

### EXAMPLES

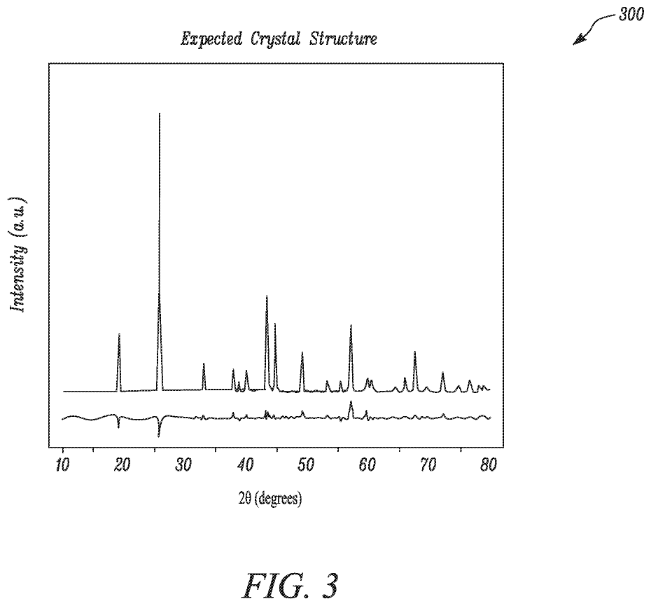

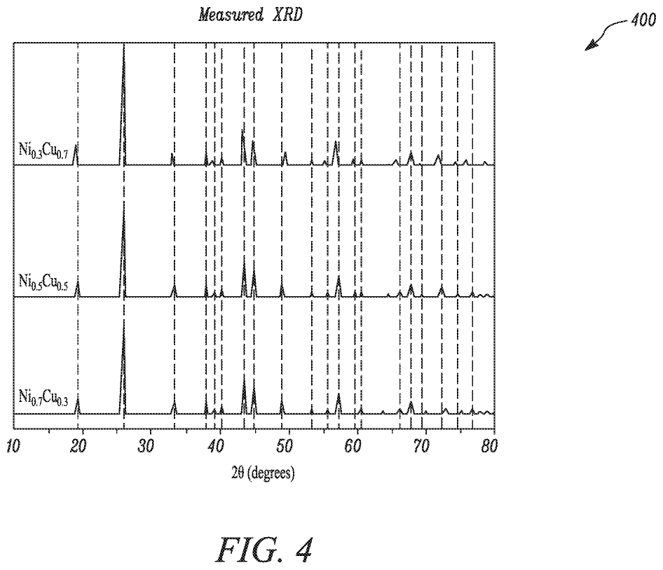

FIG. 3 is a plot 300 showing X-ray powder diffraction (XRD) of the expected crystal structure of Li₂NiₓCu₁₋ₓO₂. FIG. 4 is a plot 400 showing experimental XRD results of Li₂NiₓCu₁₋ₓO₂ for x=0.3, 0.5 and 0.7. Ni_{0.3}Cu_{0.7}, Ni_{0.5}Cu_{0.5} and Ni_{0.7}Cu_{0.3} in FIG. 4 represent Li₂Ni_{0.3}Cu_{0.7}O₂, Li₂Ni_{0.5}Cu_{0.5}O₂ and Li₂Ni_{0.7}Cu_{0.3}O₂, respectively and confirms the expected Li₂NiₓCu₁₋ₓO₂ structure.

Hardness tests were conducted on Li₂NiₓCu₁₋ₓO₂ for x=0.3, 0.5 and 0.7. Particle hardness increased with nickel (Ni) content in Li₂NiₓCu₁₋ₓO₂. Li₂Ni_{0.7}Cu_{0.3}O₂ had a comparatively high hardness value while Li₂Ni_{0.3}Cu_{0.7}O₂ had a relatively low hardness value and Li₂Ni_{0.5}Cu_{0.5}O₂ had an intermediate hardness value.

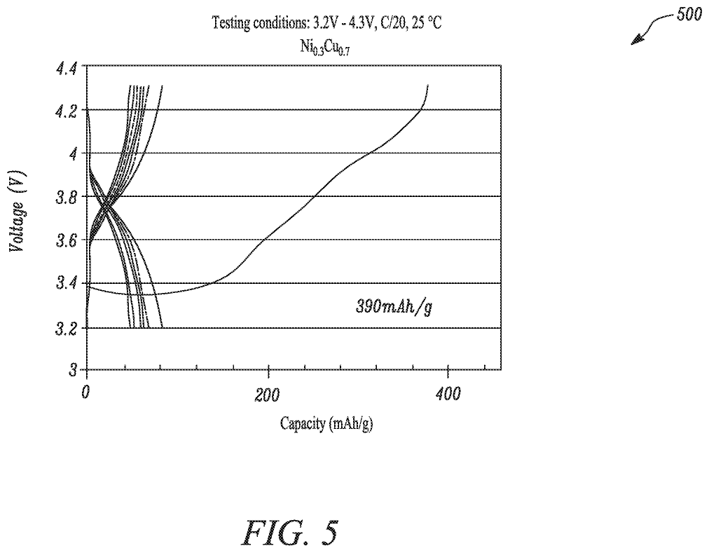

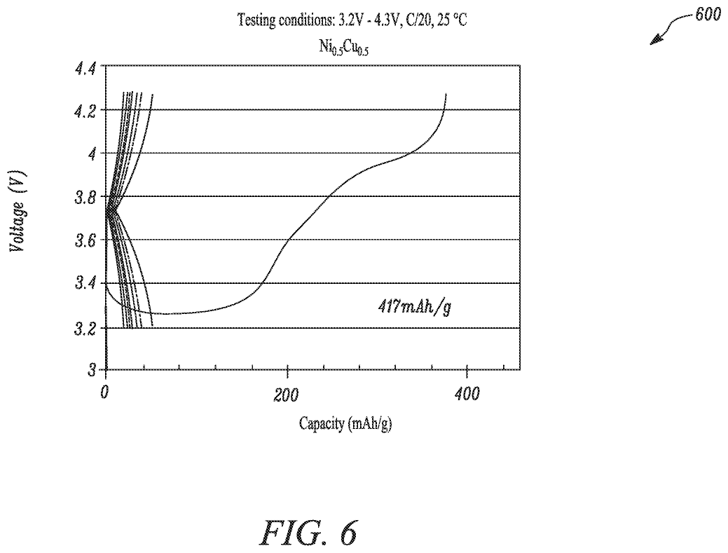

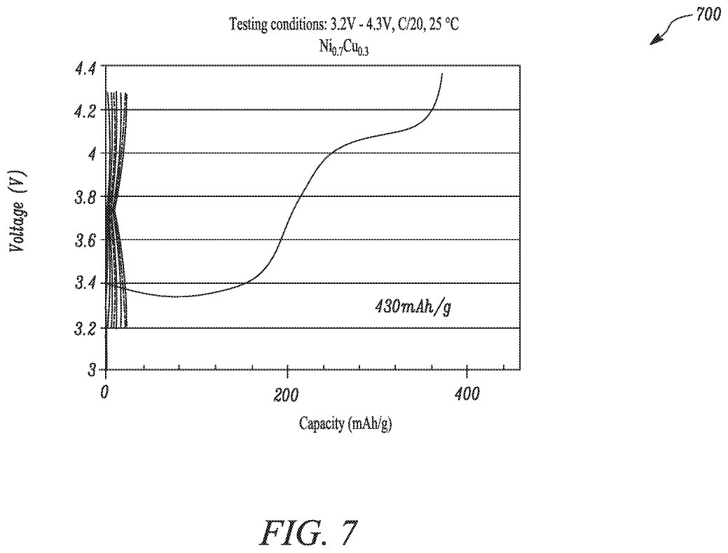

FIGS. 5, 6, 7 are plots 500, 600 and 700 showing electrochemical characterization of Li₂NiₓCu₁₋ₓO₂ for x=0.3, 0.5 and 0.7, respectively. Ni_{0.3}Cu_{0.7}, Ni_{0.5}Cu_{0.5} and Ni_{0.7}Cu_{0.3} in FIGS. 5, 6 and 7 represent Li₂Ni_{0.3}Cu_{0.7}O₂, Li₂Ni_{0.5}Cu_{0.5}O₂ and Li₂Ni_{0.7}Cu_{0.3}O₂, respectively. Each of the plots 500, 600, 700 show voltage versus charge capacity of corresponding samples. Testing conditions for each sample includes a voltage range from about 3.2 volts (V) to about 4.3 V, C/20 charging/discharge rate, and a temperature of about 25° C. C/20 charging/discharge rate may correspond to completely charging/discharging the sample for about 20 hours. Multiple cycles of C/20 charging/discharge are shown in plots 500, 600 and 700. Plots 500, 600 and 700 show that first charge capacity increases and is reversibility suppressed with decreasing nickel (Ni) content.

An exemplary method of manufacturing an electrode using the lithium-nickel-copper complex oxide (LNCO) and the lithium-nickel-cobalt-aluminum complex oxide (NCA) will be described now. A formulation of [LNCO+NCA]:Binder:Carbon may be used with about 30 grams (g) of total solids. LNCO may be synthesized by the method 200 shown in FIG. 2. The binder may be a polyvinlylidene fluoride (PVDF) binder or other suitable binder. Carbon may be carbon black or acetylene black.

A slurry of the various components of the electrode may be first formed. NCA, LNCO and carbon may be first dry mixed in a mixer for about 30 minutes (min) at about 750 revolutions per minute (rpm). The binder may be then added and mixed in the mixer for about 30 min at about 750 rpm. N-Methyl-2-pyrrolidone (NMP) solvent may be then added and mixed in the mixer for about 30 min at about 750 rpm. The slurry may be kneaded for about 10 min. The slurry may be then subjected to a final mixing in the mixer for about 15 min at a high speed, for example, about 1500 rpm. The slurry may have an overall solids content of about 78%. The slurry may be hand-coated using an elcometer machine. The hand-coated slurry may be then dried overnight at about 110° C., and then calendared to about 23 mg/cm² and about 3.2 g/cc density.

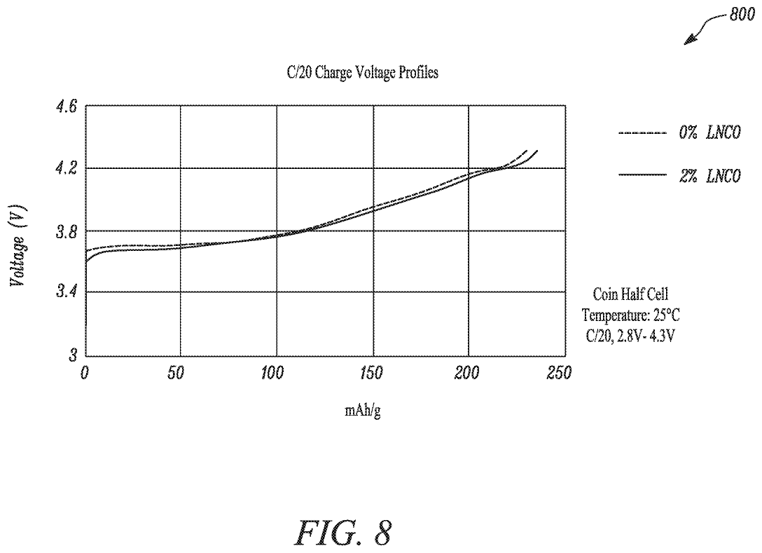

A half-cell may be formed using the electrode and an electrolyte. The half-cell may be a coin half-cell. The half-cell may be subjected to C/20 charge/discharge cycle, and variation of voltage with respect to charge capacity is measured. C/20 charge voltage profile is generated for an electrode including 0% by weight of LNCO, i.e., LNCO is absent. C/20 charge voltage profile is further generated for an electrode including about 2% by weight of LNCO. The charging conditions further include a voltage range from about 2.8 V to about 4.3 V, and a temperature of about 25° C. FIG. 8 is a plot 800 that shows voltage versus charge capacity for 0% LNCO by weight and 2% LNCO by weight. It may be apparent from plot 800 that charge capacity increases along with an increase in the weight % of LNCO.

Table 1 summarizes testing results for the coin half-cell. Data shown in Table 1 are averages from five coin cells.

TABLE 1
Coin Half Cell Results

| | Expected First | Measured First |
|---|---|---|
| | Cycle Charge | Cycle Charge |
| NCA:LNCO | Capacity | Capacity |
| Weight Ratio | (mAh/g_{active}) | (mAh/g_{active}) |
| 98:0 | 231 | 231.6 |
| 96:2 | 235 | 234.8 |

As shown in Table 1, charge capacity increases with an increase in the weight % of LNCO.

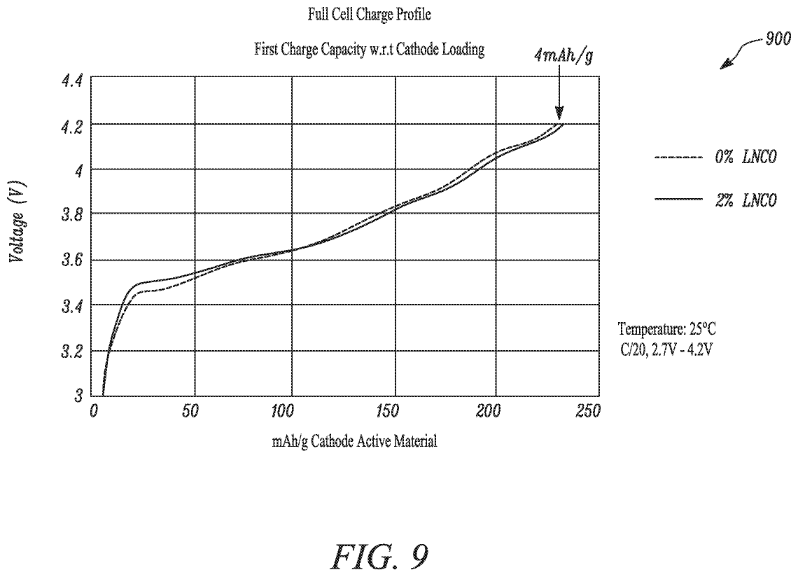

Full cell results are also reported. The cathodes may include a NCA cathode with 0% by weight of LNCO and another NCA cathode with about 2% by weight of LNCO. Anode may include a silicon monoxide (SiO) based anode material manufactured by BTR. A weight % of SiO in the anode may be about 7%. Target negative to positive capacity ratio or N—P ratio may be about 1.35. Test protocol may include formation of one cycle of C/20 charge/discharge with no degassing. Test protocol may further include a stack pressure of about 15 pounds per square inch (psi). Full cell charge profile is measured for two types of cathode active materials. One type of cathode active material is part of a NCA cathode having 0% LNCO by weight. Another type of cathode active material is part of a NCA cathode having 2% LNCO by weight. FIG. 9 is a plot 900 of voltage versus charge profile for the two types of cathode active material. In addition to a cycle of C/20 charge/discharge, testing conditions further include a voltage range from about 2.7 V to about 4.2 V and a temperature of about 25° C.

Table 2 summarizes full cell metrics. The results show that with the addition of LNCO to the cathode active material the first-cycle efficiency in full cells is improved.

TABLE 2
Full Cell Results

| | First Cycle | First Cycle |
|---|---|---|
| NCA:LNCO | Charge | Discharge |
| Weight Ratio | (mAh/g_{active}) | (mAh/g_{active}) |
| 98:0 | 228 | 177 |
| 96:2 | 232 | 181 |

Cathode active material with lithium-nickel-copper complex oxide (LNCO) represented by the formula Li₂NiₓCu₁₋ₓO₂ may also be used in pouch cells. LNCO may also improve life of cells and batteries. Particle size distribution (PSD) of LNCO may be used for density optimization of cathode. Specifically, PSD may be optimized to prevent impact on cathode density.

The system and methods above have been described in general terms as an aid to understanding details of preferred embodiments of the present disclosure. Other preferred embodiments of the present disclosure include the described application for electric vehicles. In the description herein, numerous specific details are provided, such as examples of components and/or methods, to provide a thorough understanding of embodiments of the present disclosure. One skilled in the relevant art will recognize, however, that an embodiment of the disclosure can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present disclosure.

Reference throughout this specification to “one embodiment,” “an embodiment,” or “a specific embodiment” means that a particular feature, structure, or characteristic described in connection with the embodiment is included in at least one embodiment of the present disclosure and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present disclosure may be combined in any suitable manner with one or more other embodiments. It is to be understood that other variations and modifications of the embodiments of the present disclosure described and illustrated herein are possible in light of the teachings herein and are to be considered as part of the spirit and scope of the present disclosure.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

The foregoing description of illustrated embodiments of the present disclosure, including what is described in the Abstract, is not intended to be exhaustive or to limit the disclosure to the precise forms disclosed herein. While specific embodiments of, and examples for, the disclosure are described herein for illustrative purposes only, various equivalent modifications are possible within the spirit and scope of the present disclosure, as those skilled in the relevant art will recognize and appreciate. As indicated, these modifications may be made to the present disclosure in light of the foregoing description of illustrated embodiments of the present disclosure and are to be included within the spirit and scope of the present disclosure.

Thus, while the present disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the present disclosure. It is intended that the disclosure not be limited to the particular terms used in following claims and/or to the particular embodiment disclosed as the best mode contemplated for carrying out this disclosure, but that the disclosure will include any and all embodiments and equivalents falling within the scope of the appended claims. Thus, the scope of the disclosure is to be determined solely by the appended claims.

What is claimed is:

1. An active material for an electrode, the active material comprising a lithium-nickel-copper complex oxide (LNCO) represented by the formula Li₂NiₓCu₁₋ₓO₂, wherein x is greater than 0 and less than 1.

2. The active material of claim 1, wherein x is about 0.2 to about 0.8.

3. The active material of claim 1, wherein x is 0.3, 0.5 or 0.7.

4. The active material of claim 1, further comprising a lithium-nickel-cobalt-aluminum complex oxide (NCA).

5. An electrode film for a battery, the electrode film comprising:
the active material of claim 1;
a binder; and
a carbon material.

6. The electrode film of claim 5, wherein the active material comprises about 98% by weight of the electrode film.

7. The electrode film of claim 5, wherein the binder comprises about 1% by weight of the electrode film.

8. The electrode film of claim 5, wherein the binder comprises polyvinlylidene fluoride (PVDF).

9. The electrode film of claim 5, wherein the carbon material comprises about 1% by weight of the electrode film.

10. The electrode film of claim 5, wherein the carbon material is selected from the group consisting of carbon black, acetylene black, and a conductive additive, or combinations thereof.

11. The electrode film of claim 5, wherein the LNCO comprises at least about 0.5% by weight of the electrode film.

12. The electrode of claim 5, wherein the active material further comprises a lithium-nickel-cobalt-aluminum complex oxide (NCA).

13. The electrode film of claim 12, wherein the NCA comprises at least about 96% by weight of the electrode film.

14. The electrode film of claim 12, wherein the ratio of NCA:LNCO by weight of the electrode film is about 48:1-9:1.

15. An electrode for a battery, the electrode comprising:
the electrode film of claim 5; and
a current collector.

16. A battery comprising the electrode of claim 15.

17. The battery of claim 16, wherein the electrode is a cathode electrode.

18. A method of manufacturing an active material for an electrode, the method comprising:
forming a precursor comprising lithium hydroxide (LiOH), copper(II) oxide (CuO) and nickel(II) oxide (NiO);
heating the precursor to generate a lithium-nickel-copper complex oxide (LNCO) represented by the formula Li₂NiₓCu₁₋ₓO₂, wherein x is greater than 0 and less than 1; and
forming an active material comprising the LNCO.

19. The method of claim 18, further comprising grinding the precursor after the precursor is formed.

20. The method of claim 18, further comprising milling the lithium-nickel-copper complex oxide.

21. The method of claim 18, further comprising mixing the lithium-nickel-copper complex oxide with a lithium-nickel-cobalt-aluminum complex oxide (NCA).

22. The method of claim 18, wherein the precursor is heated in an inert atmosphere.

23. The method of claim 18, wherein the precursor is heated at a temperature of about 650° C. to about 750° C.

24. The method of claim 23, wherein the precursor is heated at a temperature of about 700° C.

25. The method of claim 18, further comprising surface coating the active material with alumina (Al₂O₃).

26. A method of manufacturing an active material for an electrode, the method comprising:
forming a first precursor comprising a metal oxalate hydrate represented by the formula MC₂O₄.2H₂O, wherein M is nickel and copper;
heating the first precursor to form a metal oxide;
heating the metal oxide with a lithium precursor to generate a lithium-nickel-copper complex oxide (LNCO) represented by the formula Li₂NiₓCu₁₋ₓO₂, wherein x is greater than 0 and less than 1; and
forming an active material comprising the LNCO.

27. The method of claim 26, wherein the first precursor is formed by reacting Na₂C₂O₄ with MSO_{4.}

28. The method of claim 26, wherein the lithium precursor is lithium hydroxide (LiOH).

29. The method of claim 26, wherein heating the first precursor is performed at about 400° C. to about 500° C.

30. The method of claim 26, wherein heating the first precursor is performed in an atmosphere comprising oxygen.

31. The method of claim 26, wherein heating the metal oxide with the lithium precursor is performed at about 650° C. to about 750° C.

32. The method of claim 26, wherein heating the metal oxide with the lithium precursor is performed in an inert atmosphere.
